(19) United States
(12) Patent Application Publication
(10) Pub. No.: US 2010/0104678 A1
(43) Pub. Date: Apr. 29, 2010

(54) APPARATUS AND METHOD FOR MAKING AND USING A TOOLING DIE

(75) Inventors: Igor Y. Khandros, Orinda, CA (US); Gaetan L. Mathieu, Vareness (CA)

Correspondence Address: N. KENNETH BURRASTON;KIRTON & MCCONKIE, P.O. BOX 45120, SALT LAKE CITY, UT, 84145-0120, US

(73) Assignee: FORMFACTOR, INC.

(21) Appl. No.: 12/259,915

(22) Filed: Oct. 28, 2008

(51) Int. Cl. B28B 7/36; C25D 1/10

(52) U.S. Cl. 425/90; 205/70

(57) ABSTRACT

A method of making a tooling die can include depositing a plurality of layers onto a substrate using a printing process. Selected portions of the plurality of layers can be removed to expose a surface defining a desired shape of the tooling die. An electrically conductive material can be deposited to form a seed layer, and a structural material can be electrodeposited onto the seed layer to form the tooling die. The tooling die can be used to form contact structures on an electronic component.

### BACKGROUND

The present invention relates generally to apparatus and methods for using and making an embossing tool.

Small, resilient spring contacts provide one technique for making interconnection to microelectronics. Such contacts can provide various advantages, for example, in wafer processing, wafer testing and burn-in, finished interconnection to individual die, and related applications. Spring contacts can be used as both temporary and permanent connections to a wide variety of electronic devices.

Fabrication of spring contact elements, and in particular fine-pitch contacts, has been challenging. While various lithographic techniques are known and have achieved much success, lithographic type contacts can suffer some limitations. For example, lithographic contacts tend to have a relatively low aspect ratio and limited cross section unless a large number of fabrication steps are performed. Accordingly, using lithographic techniques to form contacts presents various limitations to the geometry of contacts that can economically be obtained.

Alternate approaches, such as fabricating spring contacts using an embossing process, have been developed which may provide the ability to produce spring contacts with improved characteristics, such as strength, stiffness, reliability, and the like. Producing spring contacts with an embossing process, however, uses a mold, which can be difficult and expensive to produce.

### SUMMARY

In some embodiments of the invention, a method of making a tooling die can include depositing a plurality of layers onto a first substrate using a printing process. The plurality of layers can include first portions and second portions, where the first portions define a desired shape of the tooling die. The method can include selectively removing the second portions to expose a surface defined by the first portions. The method can also include depositing an electrically conductive material on the first portions to form an electrically conductive seed layer. Another operation can include electrodepositing a structural material onto the seed layer to form the tooling die.

In some embodiments of the invention, a method of making a contact structure can include forming a moldable material onto an electronic component. The method can also include pressing a tooling die into the moldable material to form a pattern in the moldable material. Another operation can include printing an electrically conductive material onto the moldable material and exposed portions of the electronic component to form an electrically conductive seed layer. Yet another operation of the method can include electrodepositing structural material onto the seed layer to form a contact structure.

### BRIEF DESCRIPTION OF THE DRAWINGS

FIG. 1 is a flow chart showing a process of making contact structures on an electronic component in accordance with some embodiments of the invention.

FIGS. 2-18 show a contact structure being fabricated on an electronic component using a process as in FIG. 1 in accordance with some embodiments of the invention as described further below.

FIG. 2 is a perspective illustration of the electronic component having a plurality of terminals.

FIG. 3 is a top view illustration of the electronic component with a moldable material placed thereon.

FIG. 4 is a cross section illustration of FIG. 3.

FIG. 5 is a top view illustration of the electronic component with a tooling die being pressed into the moldable material.

FIG. 6 is a cross section illustration of FIG. 5.

FIG. 7 is a perspective illustration of the tooling die.

FIG. 8 is a top view illustration showing the impression made in the moldable material by the tooling die.

FIG. 9 is a cross section illustration of FIG. 8.

FIG. 10 is a top view illustration showing the moldable material after residual material is removed from the terminals of the electronic component.

FIG. 11 is a cross section illustration of FIG. 10.

FIG. 12A is a top view illustration showing a seed layer deposited onto portions of the moldable material and portions of the terminals.

FIG. 12B is a cross section illustration of FIG. 12A.

FIG. 13 illustrates an the electronic component showing an alternative formation of the moldable material with deposited seed layers according to some embodiments of the invention.

FIG. 14 is an exemplary apparatus for depositing droplets.

FIG. 15A is a top view illustration showing structural material deposited on the seed layer to form the contact structures.

FIG. 15B is a cross section illustration of FIG. 15A.

FIG. 16A is a top view illustration showing the finished contact structures after removal of the moldable material.

FIG. 16B is a cross section illustration of FIG. 16A.

FIG. 17A is a top view illustration showing openings formed in the moldable material of FIGS. 3 and 4.

FIG. 17B is a cross section illustration of FIG. 17A.

FIG. 18 is a cross section illustration showing a tooling die pressed into the moldable material of FIG. 17B.

FIG. 19 is a flow chart of a process for making a tooling die in accordance with some embodiments of the invention.

FIGS. 20-33 illustrate a tooling die being fabricated by a process as shown in FIG. 19 in accordance with some embodiments of the invention and described in further detail below.

FIG. 20 is a perspective illustration of a first substrate having a layer of droplets disposed thereon.

FIG. 21 is a cross section illustration of FIG. 20.

FIG. 22 is a perspective illustration of the substrate after several layers of droplets have been disposed thereon.

FIG. 23 is a cross section illustration of FIG. 22.

FIG. 24 is a perspective illustration showing selective removal of some of the droplets.

FIG. 25 is a cross section illustration of FIG. 24.

FIG. 26 is a perspective illustration showing the deposition of a conductive seed layer.

FIG. 27 is a cross section illustration of FIG. 26.

FIG. 28 is a perspective illustration showing electrodeposition of structural material onto the seed layer.

FIG. 29 is a cross section illustration of FIG. 28.

FIG. 30 is a perspective illustration, reoriented from that of FIG. 28, and showing the structural material attached to a second substrate.

FIG. 31 is a cross section illustration of FIG. 30.

FIG. 32 is a perspective illustration showing the tooling die released from the first substrate.

FIG. 33 is a cross section illustration of FIG. 32.

FIG. 34 is a perspective illustration of an alternative version of the tooling die in accordance with some embodiments of the invention.

FIG. 35 is a perspective illustration of a moldable material having depressions formed therein by the tooling die of FIG. 34 in accordance with some embodiments of the invention.

FIG. 36 is a cross section illustration of FIG. 35.

FIG. 37 is a side view illustration of a probe card assembly in accordance with some embodiments of the invention.

FIG. 38 is a side view illustration of a test socket for a semiconductor die in accordance with some embodiments of the invention.

FIG. 39 is a top view illustration of a semiconductor wafer in accordance with some embodiments of the invention.

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary embodiments and applications operate or are described herein. Moreover, the Figures can show simplified or partial views, and the dimensions of elements in the Figures can be exaggerated or otherwise not in proportion for clarity.

As the term “on” is used herein, one object (e.g., material, layer, substrate, etc.) can be “on” another object regardless of whether the one object is directly on the other object or there are one or more intervening objects between the one object and the other object. Additionally, directions (e.g., above, below, top, bottom, side, under, over, “x,” “y,” “z,” etc.) are relative and provided solely by way of example and for ease of illustration and discussion, and not by way of limitation.

In accordance with some embodiments of the invention, a method of making a contact structure will now be described generally. The method can include forming a moldable material on an electronic component. Electronic components can include, for example, semiconductor wafers, printed circuit boards, and the like. As a specific non-limiting example, the electronic component can be part of a probe card assembly, part of an interposer substrate, part of a probe substrate, a semiconductor die test socket, a semiconductor wafer having a plurality of semiconductor dies disposed thereon, or the like.

The moldable material can be deposited onto the electronic component, and a pattern can be impressed or embossed into the moldable material. Various types of moldable materials can be used, including for example, poly methyl methacrylate (PMMA), acrylic polymers, polycarbonate, polyurethane, ABS plastic, photo-resist resins (e.g., Novolac resins), epoxies, waxes, and thermoplastics in general. The moldable material can be coated onto the electronic component to a desired thickness. The thickness of the moldable material can be related to the desired height of the finish contact structures. For example, for forming contact structures having a height of about 50 micrometers, the moldable material can have a similar thickness, for example, of about 55 micrometers. Various methods can be used for forming the moldable material onto the electronic component, including for example, spin coating, dip coating, lamination, and similar processes.

The method can also include pressing a tooling die into the moldable material to form a pattern in the moldable material. For example, the tooling die can form one or more depressions in the moldable material by displacing moldable material from areas where the tooling die has raised protrusions. Portions of the electronic component can be exposed by the displacement of the moldable material, by other processes, or combinations thereof, as will become apparent from the following descriptions. Various arrangements of the tooling die can be used, and the tooling die can have been provided by various processes, including for example methods of making a tooling die as described herein.

The method can further include printing an electrically conductive material onto the moldable material and exposed portions of the electronic component to form an electrically conductive seed layer. For example, printing can be performed by an ink jet printing process, causing the electrically conductive material to be jetted onto the portions of the moldable material and the exposed portions of the electronic component. For example, the moldable material can be deposited in the form of discrete droplets. Various electrically conductive materials can be used, including for example a conductive polymer, conductive particles, nanoparticles, or a suspension of particles within a solution. If desired, after printing the electrically conductive material, the electrically conductive material can be cured.

The method can further include forming a contact structure by electrodepositing structural material onto the seed layer. For example, a metal having a similar or different composition to the seed layer can be deposited onto the seed layer. The physical geometry of the contact structure can be defined by the shape of the depression formed into the moldable material. For example, the contact structure can include one or more sloped portions, extending from the exposed portion of electronic component in a generally upward and horizontal direction relative to a top surface of the electronic component. As another example, the contact structure can have a beam portion, a post portion, or a tip portion, or combinations thereof.

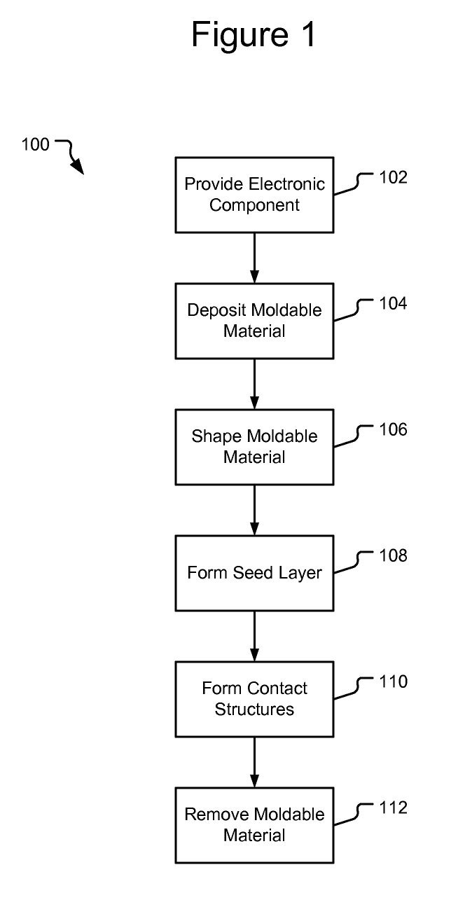

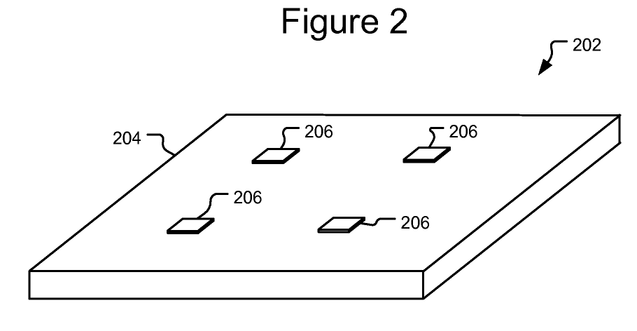

Turning now to FIG. 1, a particularly detailed example of an exemplary process for making a contact structure is shown in flowchart form, in accordance with some embodiments of the invention. FIGS. 2-18 illustrate an electronic component undergoing the process. It will be appreciated, however, that the process is not limited to the specific example illustrated here.

The process, shown generally at 100 (FIG. 1), can include providing an electronic component at 102. For example, the contact structures can be formed onto the electronic component as a part of manufacturing the electronic component, or the contact structures can be formed onto an electronic component. As noted above, the electronic component can be a semiconductor wafer having a plurality of dies disposed thereon, an element of a probe card assembly or other contactor for contacting and testing electronic devices (e.g., semiconductor dies), a printed circuit board or any other type of or element of an electronics module or device. For example, FIG. 2 shows an electronic component 202, having a substrate 204 and a plurality of terminals 206 disposed thereon. The terminals 206 provide for electronic connections to the electronic component 202, which can, for example, be used for input/output to the finished component or for access to the electronic component during testing and/or burn-in.

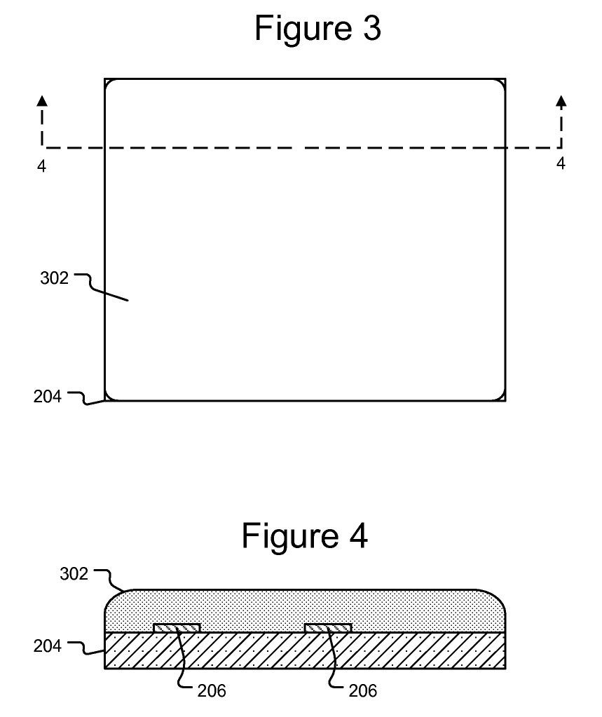

At 104, a moldable material can be deposited onto the electronic component. FIGS. 3 and 4 illustrate the moldable material 302 deposited onto the substrate 204 of the electronic component, wherein the terminals 206 can be covered by the moldable material.

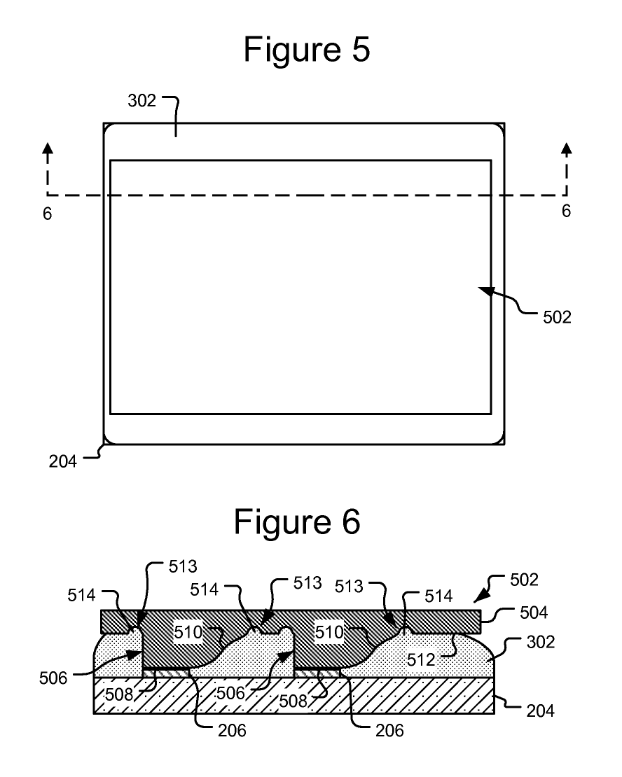

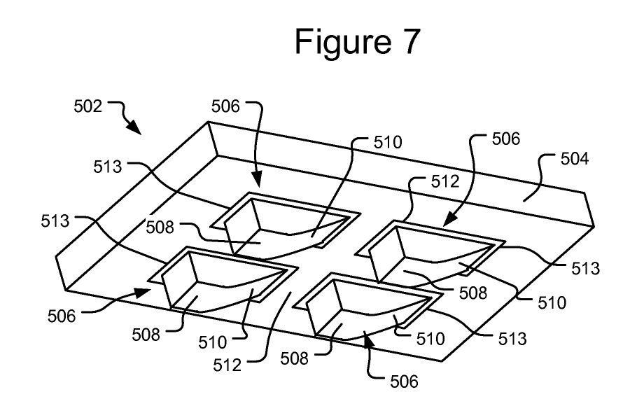

At 106, the moldable material can be shaped. For example, as shown in FIGS. 5 and 6, a tooling die 502 can be pressed into the moldable material 302 to shape the moldable material. The tooling die, also shown in isolation in FIG. 7, can include a main body 504 having teeth or protrusions 506 extending outwardly from a surface 512 of the main body. The protrusions, when pressed into the moldable material can displace portions of the moldable material to form a pattern. A plurality of protrusions can be included to define a plurality of corresponding depressions in the moldable material.

Surface portions 508, 510 of the protrusions 506 can define a desired shape of the contact structure to be formed. For example, some surface portions 508 can overlap all or part of the terminals 206 of the electronic component. Other surface portions 510 can define, for example, a sloped portion of a contact structure.

Various arrangements of the tooling die can be used to provide a desired geometry to a finished contact structure. For example, surface portions 510 can be sloped and can provide a linear slope, a convex curve, a concave curve, an S-curve, a sinusoidal shape, or the like. The surface portions can extend laterally relative to the substrate in a square shape, rectangular or beam shape, an L or J-shape, a C-shape, a U or V-shape, a spiral, a tapered shape, or the like, to enable the formation of contact elements having a similar shape. The protrusions can have the same or different profiles, allowing for fabrication of contact structures having the same or different geometries simultaneously.

It will also be appreciated that, while the above discussion describes a single application of a tooling die to the moldable material, two or more tooling dies can be successively applied to the moldable material.

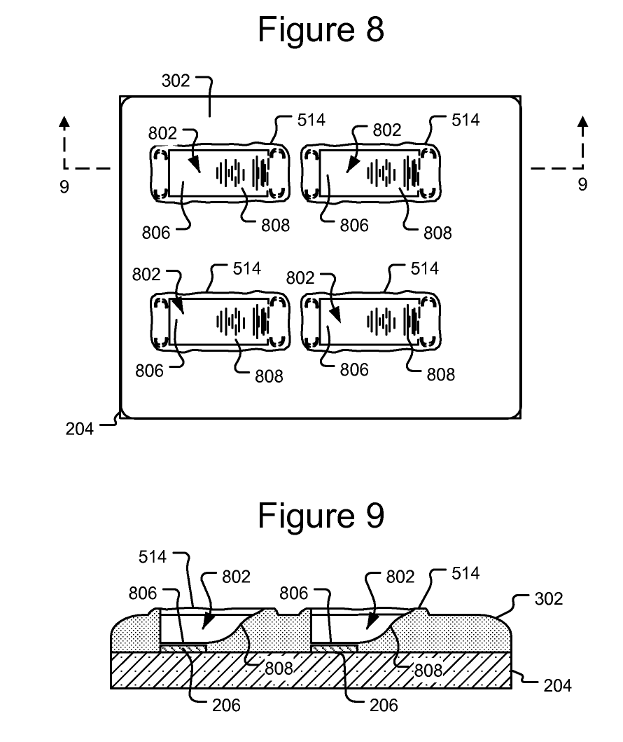

FIGS. 8 and 9 show exemplary impressions made in the moldable material 302 by the tooling die 502 after the tooling die has been pressed into the moldable material and then removed. A plurality of depressions 802 have been formed corresponding to the plurality of protrusions 506 of the tooling die. The depressions include a first portion 806 which can overlap all or part of a corresponding terminal 206. The depressions can also include a second portion 808 laterally offset having both a horizontal and vertical component in relation to the location of terminal 206. For example, the second portion can be sloped, extending laterally from the terminal. In pressing the tooling die into the moldable material, portions of the moldable material (sometimes termed “flash”) can be displaced forming ridged areas 514 surrounding the depressions, depending on the characteristics of the moldable material and the processing conditions used. Referring again to FIG. 6, the tooling die 502 can include recessed portions or areas 513 surrounding the protrusions 506 to provide space for the displaced portions of the moldable material that form ridged areas 514. Such recessed portions or areas 513, when present, can prove advantageous in further processing in helping to avoid bridging of plating material as described further below.

If desired, a layer of mold release material (not shown) can be included on the upper surface of the moldable material to assist in releasing the tooling die from the moldable material. Alternately, if desired, a layer of mold release material (not shown) can be applied to the tooling die before pressing the tooling die into the moldable material. The tool can also be coated with a non-stick material (e.g., telfon, parylene, diamond, or like materials).

If desired, the tooling die 502 can be heated to assist in displacing the moldable material 302. After the tooling die 502 is pressed into the moldable material 302, the tooling die can then be cooled to harden the moldable material so that the embossed pattern is fixed in position. As an alternative, the moldable material 302 can be a material that is sufficiently deformable so that it flows under the pressure applied by the tooling die, yet viscous enough to hold its shape after the tooling die is removed. As another example, the moldable material 302 can be softened before application of the tooling die, for example, by heating, radiation softening (e.g. ultrasonic), or other processes. As yet another example, the moldable material 302 can be hardened after application of the tooling die by the use of a chemical catalyst, radiation curing (e.g. ultraviolet), cooling, or the like. In some embodiments, tooling die 502 can be transparent or translucent, at least in part, to facilitate such curing radiation.

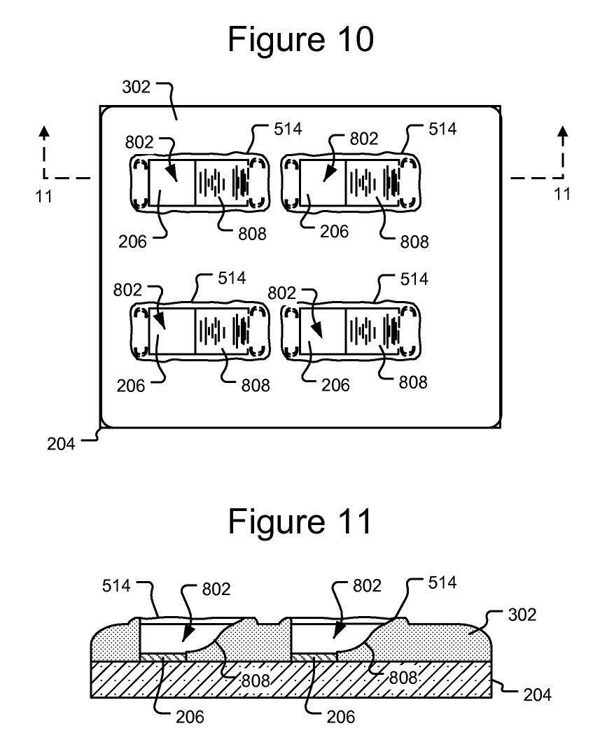

Pressing the tooling die 502 into the moldable material 302 can leave residual material 806 disposed over the terminals 206. For example the tooling die can be limited in travel to avoid coming into direct contact with the terminals 206 to help avoid damaging the terminals 206 or other structures of the electronic component 202. As the residual material can interfere with forming an electrical connection to the terminal in subsequent processing, this material can be removed. Portions of the residual material 806 can be removed by ablating, for example, using laser ablation, chemical ablation, mechanical ablation, reactive ion etching, or combinations thereof. The ablating can, for example, be performed over the entire surface of the moldable material, removing a small amount of the upper surface of the moldable material. Ablating can be performed using plasma etching, sand blasting, chemical etching, and the like. As another example, the ablating can be performed selectively using a photolithography process as described further below. FIGS. 10 and 11 illustrate the electronic component after selected portions of the moldable material 302 have been removed to expose the terminals 206 of the electronic component.

The moldable material 302 can be a photoresist. A photoresist, as is known in the art, can be exposed and developed allowing selective portions to be removed. The moldable material can be patterned by exposure to a light source through a mask. The mask can define portions of the moldable material to be kept and other portions to be removed. The photoresist can then be developed to remove exposed portions (or alternatively, unexposed portions). The removed portions can include portions overlapping all or part of the terminals.

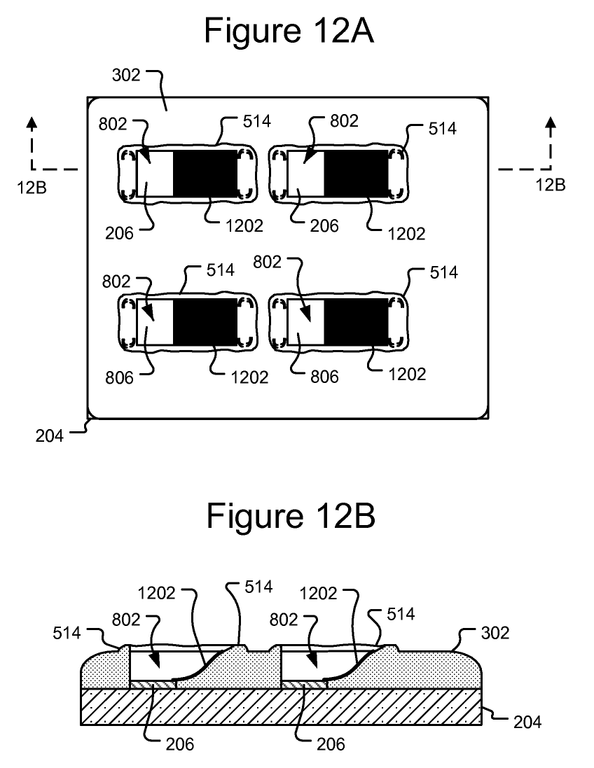

Referring again to FIG. 1, at 108, seed layer can be formed. FIGS. 12A and 12B illustrate a seed layer 1202 deposited onto portions of the moldable material 302 and in electrical contact with the terminal 206 or other portions of the electronic component. The seed layer can have a suitable thickness to provide adequate conductivity for the subsequent electrodeposition.

The seed layer 1202 can be a plurality of droplets of conductive material deposited through a printing, an ink jetting, or similar process. As noted above, the conductive material can be of various formulations, including for example, a suspension of conductive particles within a solution. In some embodiments, various ink jet printing technologies can be used to deposit the seed layer 1202. Such ink jet printing technologies include without limitation thermal, piezoelectric and continuous ink jet methods in accordance with some embodiments of the invention. As a particular example, droplets of material to be deposited can be directed from a reservoir through a spray head. A continuous stream of material can break into droplets upon emission from the spray head and the droplets can be directed by electrodes using electrostatic charges. As another non-limiting example, the droplets can be directed by airflow. Printing technologies other than jet printing can alternatively be used to deposit the seed layer 1202. Regardless of what printing technology is used, in some embodiments, printing seed layer 1202 can be a more efficient and easier way of depositing seed layer 1202 than other ways of forming a seed layer.

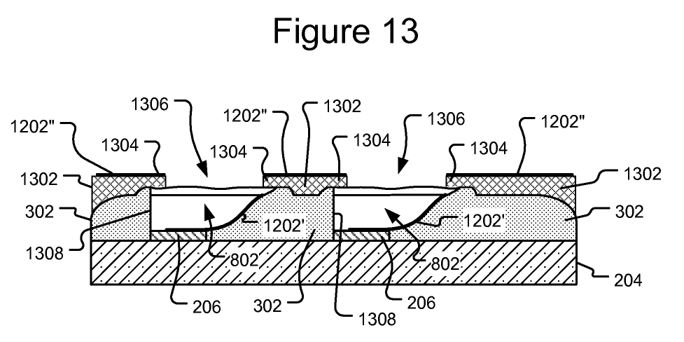

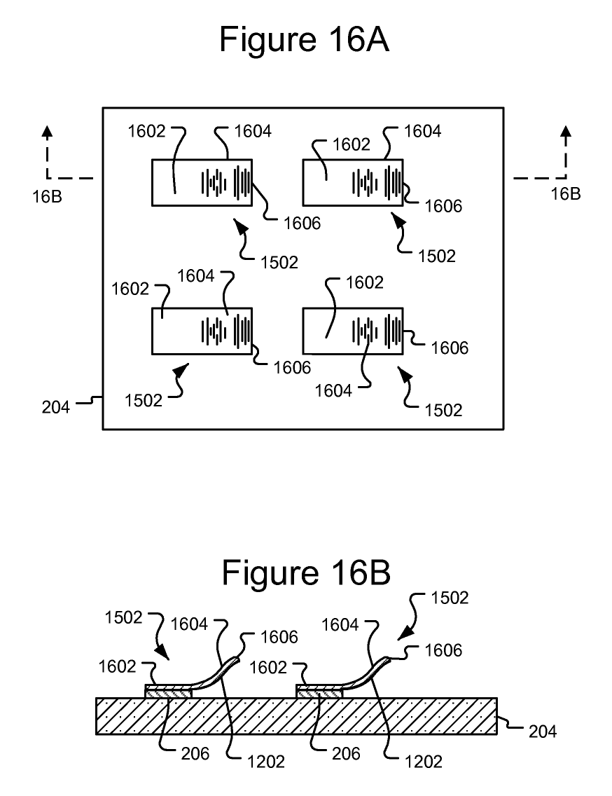

In some embodiments, seed layer 1202 can be sputtered onto portions of moldable material 302 and optionally all or part of terminal 206. Seed layer 1202 can be sputtered through a mask (not shown) with openings that correspond to desired locations on moldable material 302 and optionally terminal 206 where seed layer 1202 is to be deposited. Alternatively, as shown in FIG. 13 (which shows a same view as FIG. 12B), a layer of material 1302 can be deposited over the moldable material 302 and patterned to have openings 1306 that correspond to locations on moldable material 302 and terminals 206 where seed layer 1202 is to be deposited. As shown in FIG. 13, layer 1302 can include overhanging portions 1304 that partially extend over depressions 802. The extensions 1304 can block deposition of seed layer 1202 and thus prevent seed layer 1202 from depositing on sidewalls 1308 of depressions 802. Material forming seed layer 1202 can be sputtered onto the device shown in FIG. 13 without the use of a mask (not shown). As shown in FIG. 13, portions 1202″ of seed layer 1202 can form on layer 1302 and portions 1202′ of seed layer 1202 can form through openings 1306 onto portions of moldable material 302 and terminals 206. As mentioned, the overhanging portions 1304 can prevent the material of the sputtered seed layer material from forming on side walls 1308 of depressions 802. Layer 1302 can be a material separate from moldable material 302 that is deposited onto moldable material 302. Alternatively, layer 1302 can be an upper portion of moldable material 302 patterned to include overhanging portions 1304. Layer 1302 can be removed with moldable material 302, for example, as shown in FIGS. 16A and 16B. If layer 1302 is distinct from moldable material 302, layer 1302 can be removed any time after depositing seed layer material (see FIG. 13).

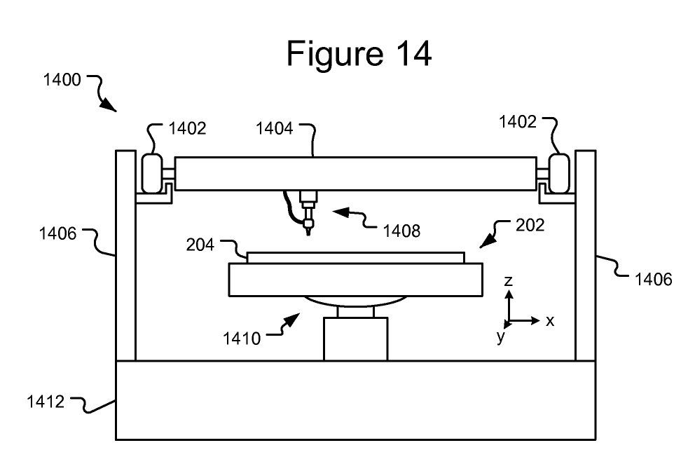

As mentioned above, seed layer 1202 can be formed by depositing droplets of conductive material on moldable material 302. FIG. 14 illustrates an exemplary system 1400 for depositing droplets of conductive material on a substrate 204 in accordance with some embodiments of the invention. The system 1400 can comprise a spray head 1408 that is connected to a control mechanism 1404 that allows for first direction or directions of movement (e.g. y direction) through rollers 1402 and second direction or directions of movement (e.g. x direction). The system 1400 can further include a base 1412 and a frame 1406 to support the control mechanism. The control mechanism can also move the spray head up and down (e.g. z direction) and can also be configured to impart other movements to the spray head, such as tilting or rotating. A chuck 1410 or other holding mechanism can hold the substrate, and the chuck can be moveable. By moving one or both of the spray head and/or substrate, droplets can be selectively deposited on the substrate through the spray head in various patterns like those described herein.

The system illustrated in FIG. 14 is exemplary only, and many variations are possible. For example, multiple spray heads 1408 can be used, and such spray heads can differ one from another facilitating, for example, dispensing droplets comprising different materials. As another example, the chuck can be heated or cooled. As another example, mechanisms for exposing droplets to ultraviolet, infrared, or other forms of electromagnetic energy or other forms of energy can be included in system 1400. For example, such exposures can change properties of the droplets.

Alternately, the seed layer 1202 can be formed by sputtering, chemical vapor deposition, or similar processes which deposit a conductive material onto the moldable material and exposed portions of the electronic device.

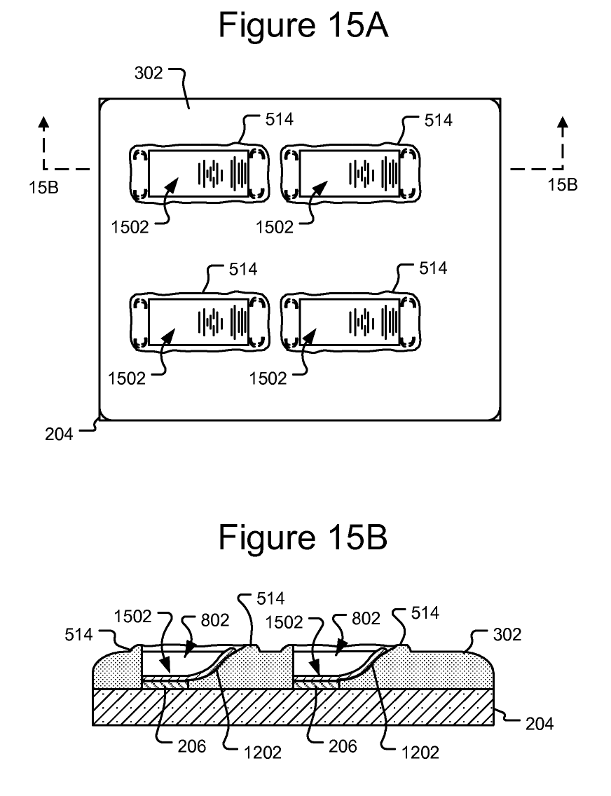

Referring against to FIG. 1, at 110, contact structures can be formed. As shown in FIGS. 15A and 15B, this can include electrodepositing structural material onto the seed layer 1202 and onto the terminal 206 to form the contact structure 1502. For example, electrodeposition can be performed by electrically connecting the seed layer 1202 to the cathode of an electroplating system (not shown) and immersing the electronic component 202 in a plating bath (not shown).

It will be appreciated that the seed layer 1202 need not contact the entire terminal 206. Since the seed layer is electrically connected to the terminal, the electrodeposition process will also deposit structural material onto the terminal. For example, the seed layer can be deposited onto a first portion of the terminal and the electrodeposition will occur onto a second portion of the terminal electrically connected to the first portion of the terminal.

Suitable structural materials include, for example, nickel, and its alloys; copper, cobalt, iron, and their alloys; gold (e.g., hard gold) and silver, both of which exhibit excellent current-carrying capabilities and good contact resistivity characteristics; elements of the platinum group; noble metals; semi-noble metals and their alloys, particularly elements of the palladium group and their alloys; and tungsten, molybdenum and other refractory metals and their alloys. Use of nickel and nickel alloys is particularly advantageous as it can provide high strength and resiliency and can provide a spring-like character to the contact structure. Tin, lead, and their alloys can also be used and can, in some embodiments, provide a solder-like finish. The structural material can further comprise more than one layer. For example, the structural material can comprise two metal layers, wherein a first metal layer, such as nickel or an alloy thereof, is selected for its resiliency properties and a second metal layer, such as gold, is selected for its electrical conductivity properties. Additionally, layers of conductive and insulating materials can be deposited to form transmission line-like structures if desired.

After the contact structures 1502 are formed at 110 of FIG. 1, the moldable material 302 can be removed at 112. For example, the moldable material can be removed (e.g., dissolved) by washing the substrate 204 with a solvent that dissolves the moldable material. (The moldable material 302 can thus be a soluble material.) FIGS. 16A and 16B show the finished contact structures 1502 after the moldable material has been removed. The contact structures can include a base portion 1602 which can be electrically and mechanically coupled to the terminal 206. The contact structures 1502 can also include a cantilevered beam portion 1604 which can be cantilevered from the terminal. The mechanical properties of the second portion can be a function of the structural material that is electrodeposited in combination with the geometric configuration of the contact structure defined by the shape of the depression and the thickness of the electrodeposition. The contact structure can thus provide a resilient or spring-like quality to enhance its performance when used to form pressure contacts. The contact structures 1502 can also include a tip portion 1606.

Residual seed material 1202 is shown in FIG. 16B as forming a part of the contact structures 1502. However, since the residual seed material 1202 was used, in this example, to enable electroplating of the structural material, the residual seed material can be removed from the finished contact structure if desired. For example, the residual seed material can be removed by etching or dissolving. As another example, the seed material and the moldable material can be soluble in the same solvent, allowing removal of the moldable material and the seed material in a single step. The residual seed material 1202, however, need not be removed.

If desired, a high electrical conductivity coating can be disposed onto part or all of a contact structure 1502 to provide improved electrical performance to the contact structure. For example, an entire surface of a contact structure 1502 can have the high conductivity coating. As another example, a tip portion of the contact structure can be coated. For example, tip 1606 in FIGS. 16A and 16B can be coated with high conductivity material (not shown). The high conductivity material can be, for example, gold, copper, silver, etc.

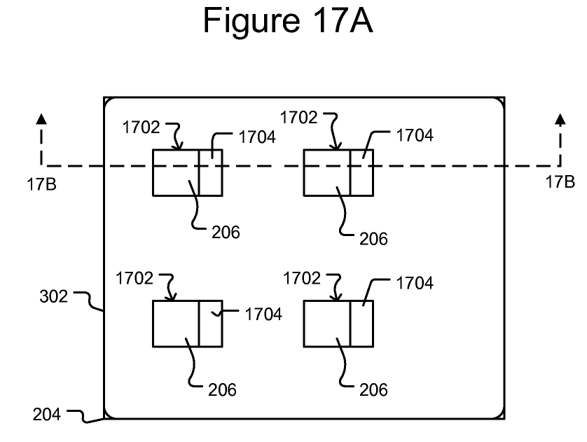

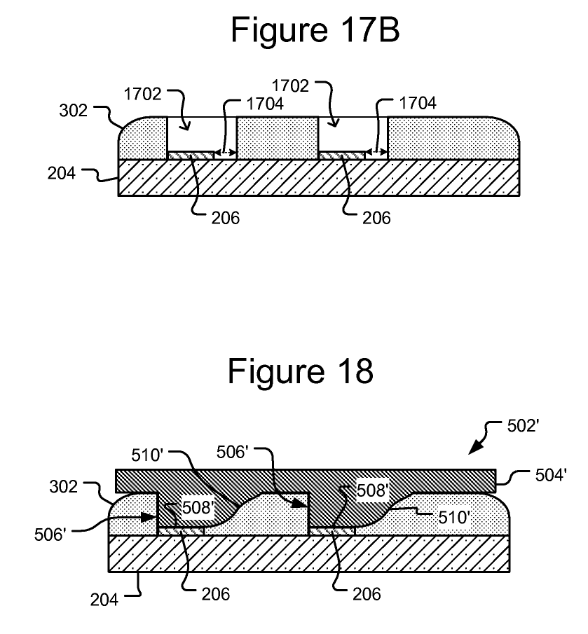

The examples shown in FIGS. 2-16B are not exclusive, and variations are possible. For example, as shown in FIGS. 17A and 17B, openings 1702 can be formed in the moldable material 302 of FIGS. 3 and 4. Each opening 1702 can expose a terminal 206 on the substrate 204, and each opening 1702 can also include a gap 1704 exposing a portion of the substrate 204 adjacent the terminal 206. The gap 1704 can provide space for portions of the moldable material 302 displaced (e.g., flash) when a tooling die 502′ is pressed into the moldable material 302 as shown in FIG. 18. Because of the gaps 1704, the tooling die 502′ need not include the recessed portions or areas 513 of the tooling die 502 shown in FIGS. 6 and 7, which as discussed above, can surround the protrusions 506 and provide space for displaced material 302 that forms ridged areas 514 of the moldable material 302 shown in FIG. 6. Otherwise, however, the tooling die 502′ can be like the tooling die 502 of FIGS. 6 and 7. For example, as shown in FIG. 18, the tooling die 502′ can include a main body 504′ like the main body 504 of the tooling die 502 of FIGS. 6 and 7 and protrusions 506′ like the protrusions 506 of the tooling die 502. Moreover, the protrusion 506′ can include surface portions 508′ and 510′ that can be like surface portions 508 and 510 of the protrusions 506 of the tooling die 502. The gaps 1704 shown in FIGS. 17A and 17B can be sized to provide sufficient space for the volume of the moldable material 302 displaced when the tooling die 502′ is pressed into the moldable material 302 as shown in FIG. 18. The openings 1702 can be formed in the moldable material 302 after the moldable material is deposited on the substrate 204 as shown in FIGS. 3 and 4, and the pressing of tooling die 502′ into the moldable material 302 shown in FIG. 18 can replace the pressing of the tooling die 502′ into moldable material 302 shown in FIGS. 5 and 6. Thereafter, processing can be generally as shown in FIGS. 8-16B.

It will be appreciated that various geometries of contacts can be formed using the above described process. Furthermore, the individual contacts fabricated by the process need not all be identical. The tooling die can include various differently shaped protrusions, allowing for multiple contacts having differing geometries to be simultaneously made by the process. For example, commonly-owned U.S. Pat. No. 7,189,077 entitled, “Lithographic Type Microelectronic Spring Structures with Improved Contours” (attorney docket number P108) provides several different examples of contact structures which can be fabricated using the presently disclosed techniques.

Turning to the tooling die in further detail, various arrangements of the tooling die can be used. For example, commonly-owned U.S. Pat. No. 6,780,001, entitled “Forming Tool for Forming a Contoured Microelectronic Spring Mold,” (attorney docket number P110) describes various arrangements of a tooling die which can be used in the presently disclosed techniques.

Alternately, a tooling die can be made as will now be described in accordance with some embodiments of the invention. A method of making a tooling die can include depositing a sequential plurality of layers onto a substrate using a printing process. The layers can comprise first portions and second portions, wherein the first portions define a desired shape of the tooling die. For example, the printing process can include using an ink jet printing process to deposit droplets to form one or more of the layers. Some droplets can be of various different materials to provide desired structural, electrical, and/or chemical properties, for example as described further below.

The method can also include selectively removing the second portions to expose a surface defined by the first portions. For example, second portions can be removed using a solvent which dissolves the second portions and does not dissolve (or does not appreciable dissolve) the first portions. (The second portions can comprise a material that is soluble (or appreciably soluble in the solvent, and the first portions can comprise a material that is not soluble (or not appreciably soluble) in the solvent.) As used herein, a material is not “appreciably” soluble in a solvent (i.e., the solvent does not “appreciably” dissolve the material) if (1) the material is part of a structure and the amount of the material dissolved by the solvent does not affect the intended use or function of the structure, or (2) the solve rate of the material in the solvent is at least five times the solve rate of another material that is also exposed to the solvent.

The method can further include depositing an electrically conductive material onto the surface to form an electrically conductive seed layer. For example, depositing the electrically conductive material can be performed using any of sputtering, vapor depositing, atomic deposition, electroless plating, surface chemistry sensitization, and combinations thereof. As another example, depositing the electrically conductive material can be performed by printing the electrically conductive material, for example, using ink jet printing.

The method can include electrodepositing a structural material onto the seed layer to form the tooling die.

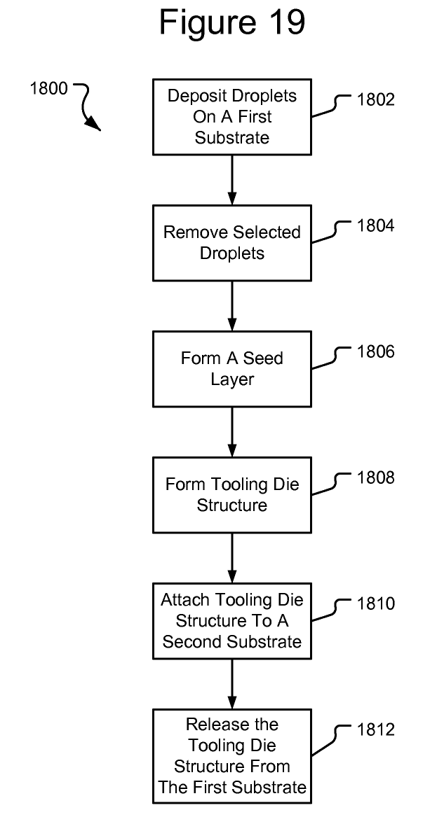

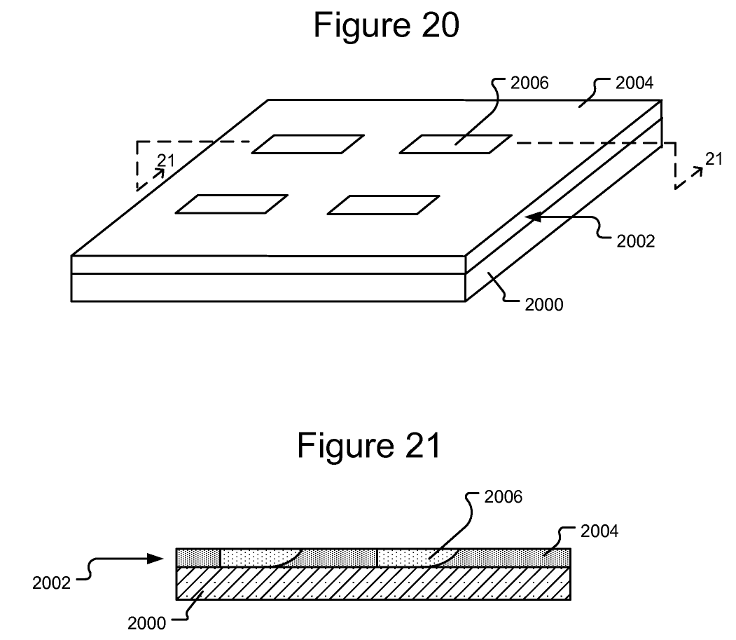

Turning now to FIG. 19, a particularly detailed example of a process 1800 for making a tooling die is shown in flowchart form, in accordance with some embodiments of the invention. FIGS. 20-32 illustrate a tooling die being formed according to the process. It will be appreciated, however, that the process is not limited to the specific example illustrated here.

At 1802 of the process 1800, droplets can be deposited on a first substrate. As shown in FIGS. 20 and 21, a substrate 2000 can be provided, onto which one or more layers 2002 of droplets can be deposited thereon. For example, as shown here, one layer can be formed from two different types of droplets (the individual droplets are not shown). A first portion 2004 can be defined using first droplet composition, and a second portion 2006 can be defined using a second droplet composition. The second portion can correspond to portions that will be later removed in the process.

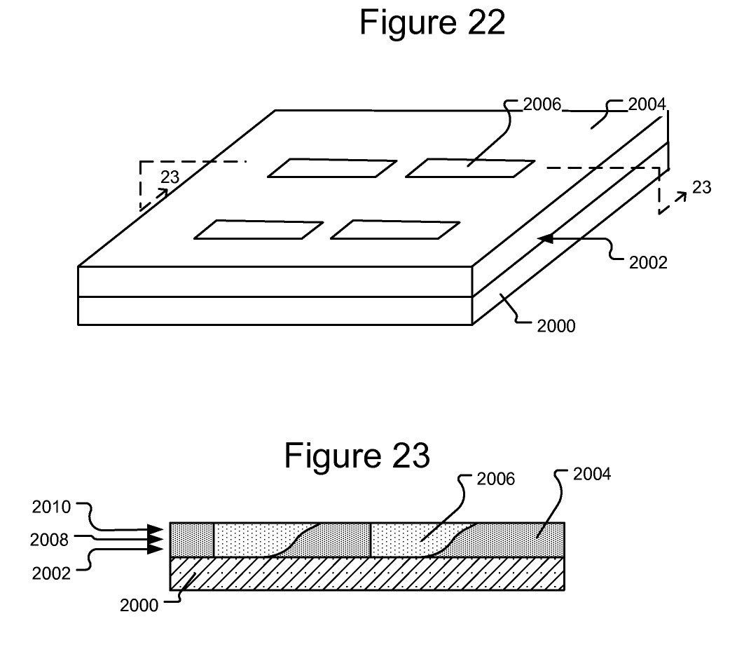

As shown in FIGS. 22 and 23, the droplets can be deposited in multiple layers 2002, 2008, 2010, allowing for large vertical extent features to be formed on the tooling die. The use of more than one material can allow for features to be defined while maintaining a generally flat surface, allowing additional layers to be deposited on previously deposited layers. This can simplify the printing process, since printing on a flat surface can be easier than printing on a profiled surface. Moreover, maintaining a relatively solid layer can help to maintain the integrity of the structures formed, for example, if an intermediate curing step is performed after the printing. As another example, depositing the droplets in layers 2002, 2008, 2010 can facilitate structural integrity for overlapping structures or for structures with relatively thin portions (e.g., walls).

If desired, after depositing one or more layers of droplets, the layers can be planarized prior to depositing a next layer of material to provide an even flatter surface for printing. Planarizing can be performed using various processing, including for example mechanical grinding (e.g., using diamond based grinders, silicon-carbide based grinders, etc.), chemical processes (e.g., using slurries of silicon dioxide, aluminum oxide, cesium oxide, etc.), milling processes (e.g., using a rotating end mill), like processes, and combinations thereof.

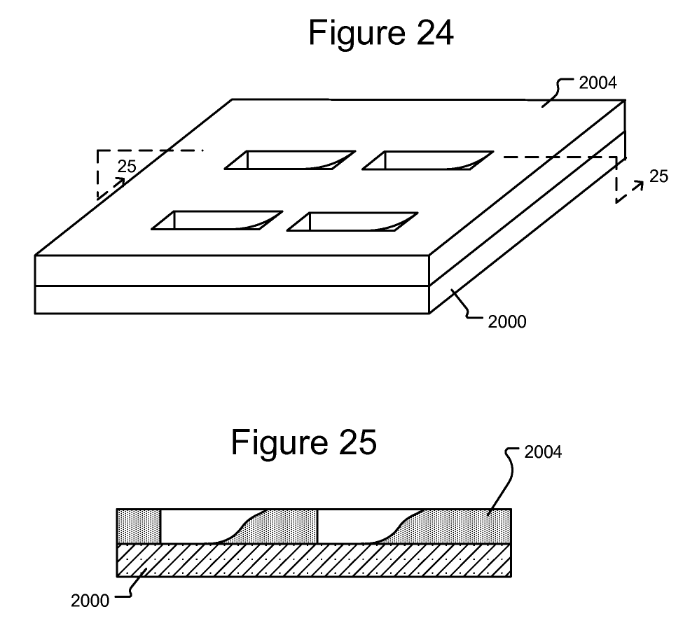

At 1804 of the process 1800, selected droplets can be removed. For example, the first portions 2004 can comprise droplets of a first material insoluble (or not appreciably soluble) in a selected solvent and the second portions 2006 can comprise droplets of a second material soluble in the selected solvent. The selected droplets can therefore be removed by applying the solvent to the plurality of layers. FIGS. 24 and 25 illustrate the partially fabricated tooling die after removing at 1804 selected droplets. For example, the second material can be a water-soluble material, in which case rinsing with water can be used to dissolve and remove the second material. After removing the selected droplets, the remaining material can act as a support structure to define a desired shape of the tooling die. Alternatively, droplets can be deposited at 1802 of FIG. 19 only in the pattern shown in FIGS. 24 and 25 of the first portions 2004 such that droplets are not deposited in the second portions shown in FIGS. 22 and 23. In such a variation, droplets need not be removed at 1804 of FIG. 19.

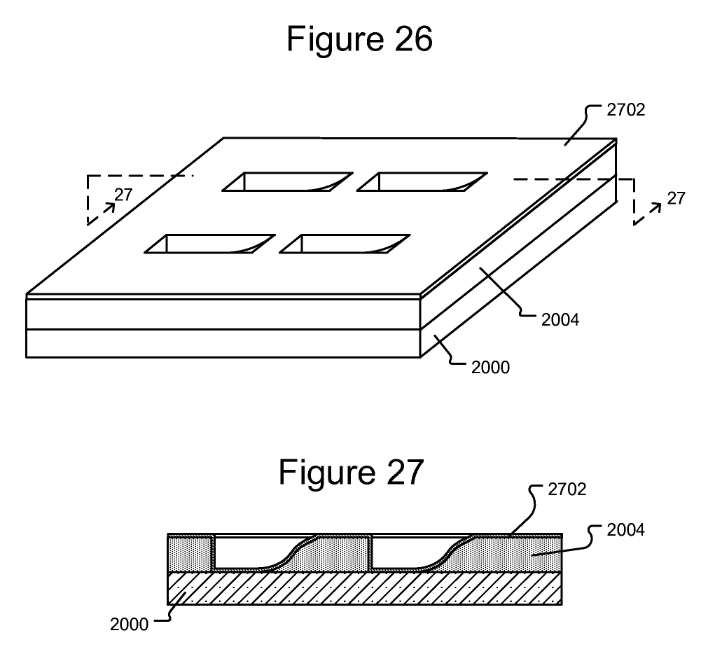

At 1806 of the process 1800, a seed layer can be formed on the support structure. As shown in FIGS. 26 and 27, the seed layer 2702 can be formed on top of the first portions 2004. The seed layer can be an electrically conductive material, for example, a conductive polymer or suspension of conductive particles (e.g., nanoparticles) in a solution. The seed layer can be formed using a variety of processes, such as printing, as described above. If desired, the seed layer can be cured to form a continuous electrically conductive layer on the support structure. As another example, the seed layer can be deposited using a lithographic process (e.g. masking, lift off, etc.).

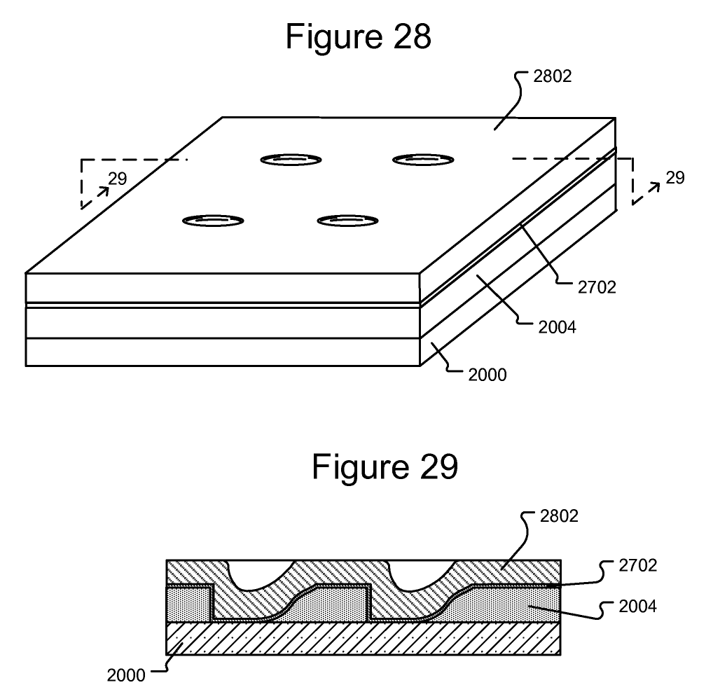

Referring against to FIG. 19, following depositing of the seed layer at 1806, the tooling die structure can be formed at 1808. This can be performed, for example, by electrodepositing a structural material onto the seed layer as described above. Various materials can be electrodepositing onto the seed layer, including for example, nickel, copper, iron, and the like. FIGS. 28 and 29 show the tooling die structure after electrodeposition of the structural material 2802 onto the seed layer 2702. The structural material can be significantly thicker than the seed layer.

In general, the seed layer 2702 can define a surface profile of the tooling die that is used for embossing or stamping into a moldable material, and thus the desired surface profile can be defined by the first portions 2004 and the seed layer. By using small droplets to define the first portions 2004, fine control over the surface contour can be maintained. In contrast, the dimensions of the structural material 2802 can be less important to control, and thus rounding of sharp corners and filling in of depressions during the electrodeposition are of lesser concern since they do not affect the surface profile.

As alluded to above, deposition of the droplets can be performed using a printing process, such as ink jet printing. For example, the apparatus of FIG. 14 described above can be used. Various types of materials can be used for the droplets, depending on the function to be performed. For example, a first type of droplets can be used to provide support for other droplets that are removed once the layers have been deposited. The first type of droplets can be made of a material that is readily removed through a process that does not remove appreciable numbers of others of the droplets, such as a material that is soluble in a first solvent. Examples include, without limitation, water soluble resins (e.g., polyacrylic acid, polyacrylamide, etc.), and mixtures of or materials containing the foregoing. As another example a material marketed under the trade name FullCure S-705 by Objet Geometries, Ltd. of Rehovot, Israel or Stratasys, Inc. of Eden Praine, Minn. can be used. Examples of suitable solvents for dissolving, the first set of droplets include, without limitation, water, water mixed with an organic solvent (e.g., methanol, ethanol, isopropanol), etc. Rather than dissolving the first set of droplets, such solvents can be used in lifting the first set of droplets off of substrate 204 and/or other droplets on substrate 204. As yet another example, such solvents can be used in pulling the first set of droplets apart from substrate 204 or other droplets on substrate 204.

The second type of droplets can form portions of the layer which are not removed. Suitable material can be a material that is not soluble in the first solvent (the solvent that removes the first type of droplets). The second type of droplets can—but need not—be soluble in a second solvent that is different than the first solvent. Examples of suitable materials for the second set of droplets include, without limitation, acrylate polymers, methacrylate polymers, polystyrenes, polycarbonates, thermoplastics, thermoplastic resins, acrylonitrile-butadiene-styrene copolymers, and mixtures of or materials containing the foregoing. Examples of suitable solvents for dissolving the second set of droplets include, without limitation, acetone, propylene glycol methyl ether acetate (PGMEA), toluene, xylene, mesitylene, aromatic hydrocarbons, solvents that selectively remove thermoplastic resins, etc.

If desired, additional droplet types, such as droplets which are not soluble in either the first or the second solvent can also be used. Examples of suitable materials for such third type of droplets include, without limitation, polymers, polyphenylene sulfides, polyimides, polyetherimides, polyether-etherketones, epoxy resins, polyetones, and mixtures of or materials containing the foregoing. A material marketed under the trade name FullCure M-720 by Objet Geometries, Ltd. of Rehovot, Israel or Stratasys, Inc. of Eden Praine, Minn. is also a suitable material for the third type of droplets.

Droplets for forming a conductive material can include droplets which are—but need not be—eventually removed. For example, droplets of the conductive material can be a material that is soluble in the second solvent and thus can be removed only with the second type of droplets. Alternatively, the droplets of the conductive material can be soluble in another solvent that is different than the first solvent and the second solvent. Examples of suitable materials for the conductive droplets include, without limitation, electrically conductive fluid that can be deposited on top of previous layers of droplets, including, without limitation, polyaniline, polythiophene, and mixtures of or materials containing the foregoing. A conductive ink marketed under the trade name NanoPaste by Harima Chemical, Inc. of Japan or Harimatec, Inc. of Duluth, Calif. can be used. Other non-limiting examples of materials suitable for the conductive droplets include, without limitation, polymers (e.g., epoxies, silicones, etc.) containing metal pieces or particles.

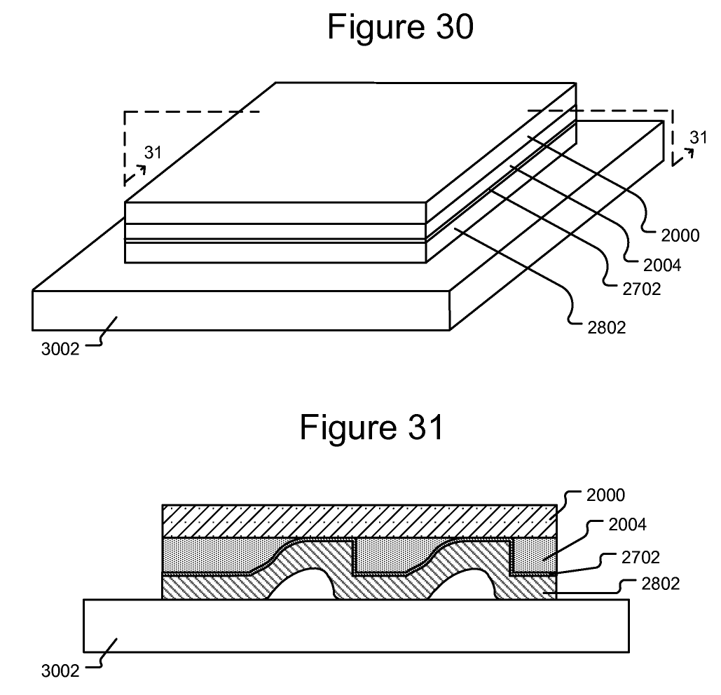

Returning to the discussion of the process 1800, once the material forming the tooling die has been deposited, the tooling die can be attached to a second substrate. As shown in FIGS. 30 and 31, the tooling die can be attached to a second substrate 3002. This attachment can be performed, for example, by bonding, gluing, brazing, welding, or similar processes.

If desired, filler or reinforcing materials (not shown), such as plastic, glass, epoxy, or the like can be deposited onto the structural material before attaching the structural material to the second substrate. For example a liquid plastic material can be flowed or coated onto the structural material and then hardened, for example, by heating, cooling, chemical processes, or ultraviolet curing, or the like. Also, if desired, an upper surface of the structural material can be planarized before attachment to the second substrate.

After attaching the tooling die to the second substrate at 1810 in the process 1800, the tooling die can be released from the first substrate 2000. For example, the tooling die 502 can be separated from the first substrate 2000 and the first portions by dissolving the first portions in a second solvent. The first substrate can be discarded, or can be reused for forming additional tooling dies. The seed layer 2702 can be left on the tooling die, or can be removed if desired. For example, the seed layer 2702 can be removed by etching or dissolving as described above.

Alternately, if desired, the tooling die can be removed from the first substrate before being attached to the second substrate (i.e., performing 1812 and then performing 1810 in the process 1800 of FIG. 19).

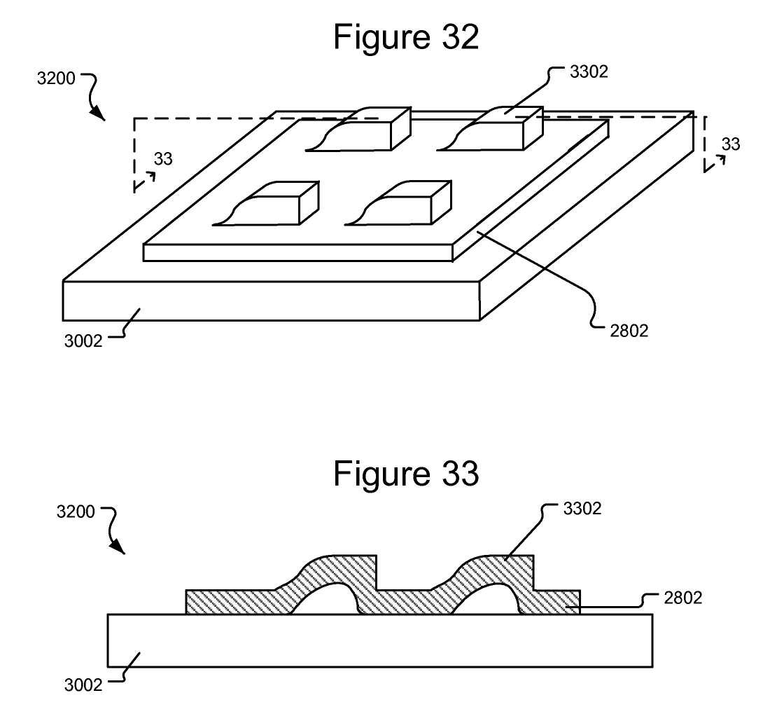

FIGS. 32 and 33 illustrate an exemplary completed tooling die 3200 comprising the structural material 2802 attached to a second substrate 3002. The structural material can include a plurality of protuberances 3302. The tooling die can be used for embossing a moldable material, for example, a moldable material placed onto a third substrate, as described above. When pressed into a moldable material, the protuberances can produce corresponding depressions in the moldable material, for example, as described above. The tooling die can, for example, be used to form a contact structure on the third substrate according to the methods and processes as described above.

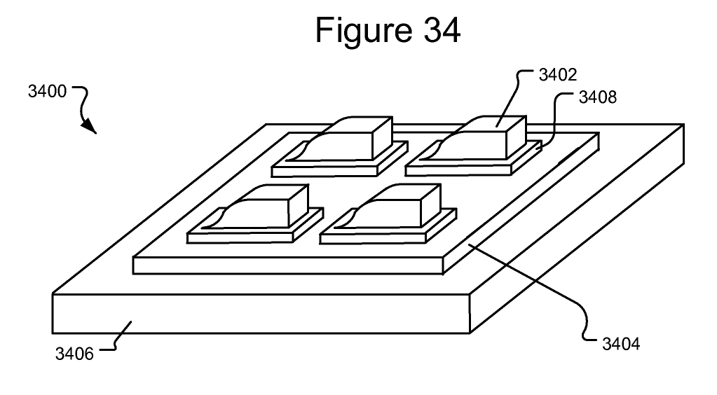

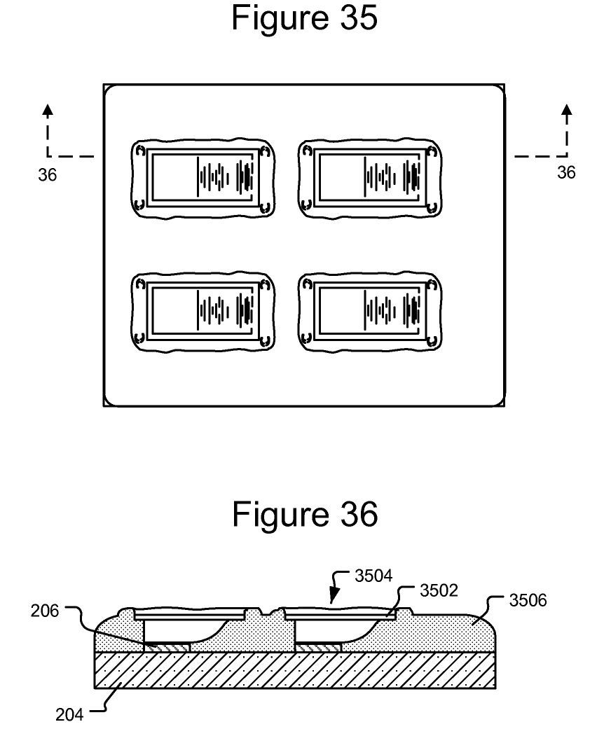

FIG. 34 shows an alternate arrangement of the tooling die in accordance with some embodiments of the invention. The tooling die 3400 can include a plurality of protuberances 3402 formed in a structural material 3404. The structural material can be attached to a substrate 3406. The protuberances can include platforms 3408. As shown in FIGS. 35 and 36, the platforms can help to provide a shelf 3502 within the depressions 3504 that are formed within a moldable material 3506 when embossing is performed.

The shelves 3502 can be beneficial when electroplating is performed as part of forming a contact structure. The shelves can help to prevent the plated material from running together or bridging between adjacent contacts.

The tooling die 3400 can be a non-limiting example of a tooling die 502 (see FIG. 7) that can be used at 106 of the process 100 of FIG. 1 to shape moldable material 302 (see FIGS. 5 and 6). Referring again to the process of FIG. 1, while that process for making contact structures has been illustrated to show formation of contact structures on one side of an electronic component, it will be appreciated that the techniques can be applied to both sides of an electronic component simultaneously. Thus, two tooling dies 502 can be used, moldable material 302 can be deposited on both sides of the electronic component 202, patterns can be embossed into the moldable material 302 from both sides, and seed layers 1202 and structural material forming contact structures 1502 can deposited as described above. Alternatively, the process of FIG. 1 can be performed first on one side of electronic component 202 (e.g., as illustrated in FIGS. 2-18) and then on the opposite side of electronic component 202 (e.g., also generally as illustrated in FIGS. 2-18).

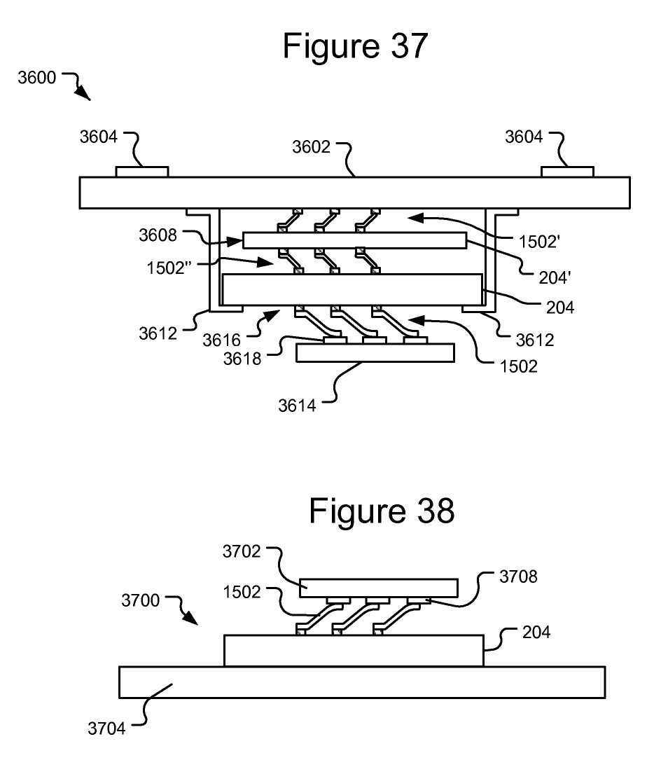

As mentioned, there are many possible uses and applications for an electronic component comprising substrate 204 with contact structures 1502 on one side (e.g., as illustrated in FIGS. 16A and 16B) or both sides (as discussed above). FIG. 37 illustrates an exemplary probe card assembly 3600 with a probe substrate 3616 that can comprise substrate 204 with contact structures 1502, which can be made in accordance with the process 100 of FIG. 1 and the example shown in FIGS. 2-18. As shown, probe card assembly 3600 can also have an interposer 3608, which can comprise a substrate 204′ with contact structures 1502′ on one side of the substrate 204 and contact structures 1502″ on the other side of the substrate. Substrate 204′ can be like substrate 204 of FIGS. 2-18, and contact structures 1502′ and 1502″ can be like contact structures 1502 and can be made generally in accordance with the process 100 of FIG. 1 and the example shown in FIGS. 2-18. Alternatively, only one of interposer 3608 or probe substrate 3616 can comprise a substrate like substrate 204 and contact structures like contact structures 1502.

Turning now to a description of the exemplary probe card assembly 3600, it can include three substrates: a wiring board 3602, an interposer 3608, and a probe substrate 3202. An electrical interface 3604 can provide electrical connections to and from a tester (not shown). Interface 3604 can be any suitable electrical connection structure, including without limitation, pads for receiving pogo pins, zero-insertion-force connectors, or other connection devices for making electrical connections with the tester.

Electrical connections (e.g., electrically conductive terminals, vias and/or traces) (not shown) can provide electrical connections from the interface 3604 through the wiring board 3602 to contact structures 1502′, which can be electrically conductive and can form pressure connections with terminals (not labeled) on wiring substrate 3602. Additionally, electrical connections (e.g., electrically conductive terminals, vias and/or traces) (not shown) can be provided through the substrate 204′ to connect the contact structures 1502′ with contact structures 1502″, which can be electrically conductive and can form pressure connections with terminals (not labeled) on substrate 204. Additionally, electrical connections (e.g., electrically conductive terminals, vias and/or traces) (not shown) can electrically connect the contact structures 1502″ through the probe substrate 3616 to the contact structures 1502, which can function as probes disposed to contact terminals 3618 of an electronic device or devices (hereinafter “DUT”) 3614 to be tested. Electrical connections (not shown) can thus be provided from the interface 3604 through the probe card assembly 3600 to the contact structures 1502.

The probe card assembly 3600 can be used, for example, to test DUT 3614. The contact structures 1502 can be brought into pressure electrical contact with terminals 3618 of DUT 3614, enabling a tester (not shown) connected to the interface 3604 of the wiring board 3602 to perform tests on the DUT.

DUT 3614 can be any type of electronic device. Examples of DUTs 3614 include any type of electronic device that is to be tested, including without limitation one or more dies of an unsingulated semiconductor wafer, one or more semiconductor dies singulated from a wafer (packaged or unpackaged), an array of singulated semiconductor dies (packaged or unpackaged) disposed in a carrier or other holding device, one or more multi-die electronics modules, one or more printed circuit boards, or any other type of electronic device or devices. Note that the term DUT, as used herein, refers to one or a plurality of such electronic devices.

The probe substrate 3616 and interposer 3608 can be secured to the wiring board 3602 using various means, including, without limitation, bolts, screws, clamps, brackets, etc. In the illustrated embodiment, the probe substrate and the interposer are secured to the wiring board by way of brackets 3612.

The probe card assembly illustrated in FIG. 37 is exemplary only and many alternative and different configurations of a probe card assembly can be used. For example, a probe card assembly can include fewer or more substrates (e.g., 3602, 3608, 3616) than the probe card assembly illustrated in FIG. 37. For example, interposer 3608 can be eliminated, and terminals (not labeled) on the lower surface of wiring board 3602 can be connected to terminals (not labeled) on the upper surface of substrate 204 by solder, flexible wires, or any other electrical connections. As another example, the probe card assembly can include more than one probe substrate (e.g., 3612), and each such probe substrate can be independently adjustable. Non-limiting examples of probe card assemblies with multiple probe substrates are disclosed in commonly-owned U.S. patent application Ser. No. 11/165,833, filed Jun. 24, 2005, entitled “Method and Apparatus for Adjusting a Multi-substrate Probe Structure,” (attorney docket number P230). Additional non-limiting examples of probe card assemblies are illustrated in commonly-owned U.S. Pat. No. 5,974,662, entitled “Method of Planarizing Tips of Probe Elements of a Probe Card Assembly,” (attorney docket number P6) and U.S. Pat. No. 6,509,751, entitled “Planarizer for a Semiconductor Contactor” (attorney docket number P101). Various features of the probe card assemblies described in the above references can be implemented in a probe card assembly in accordance with some embodiments of the present invention.

Alternately, the substrate 204 with contact structures 1502 need not be part of a probe card assembly, but can be a part of any of many different types of electrical devices. One example of such an electronic device is a test socket such as the exemplary test socket 3700 illustrated in FIG. 38. As shown, FIG. 38 shows an exemplary test socket 3700 for testing an electronic device 3702 in accordance with some embodiments of the invention. The test socket can be disposed on a printed circuit board 3704 or other wiring substrate and can include contact structures 1502 on substrate 204 (as made in accordance with the exemplary process 100 of FIG. 1) for making pressure contacts with terminals 3708 of an electronic device 3702 to be tested. The electronic device 3702 can be any electronics device such as, for example, a semiconductor die (packaged or unpackaged) or electronic device 3702 can be any of the devices described above with regard to DUT 3614 of FIG. 37. The printed circuit board 3704 can include an electrical interface (not shown) to a tester (not shown) for controlling testing of electronic device 3702 and internal wiring (not shown) for electrically connecting the electrical interface (and thus the tester) to internal wiring (not shown) in substrate 204 and thus to contact structures 1502.

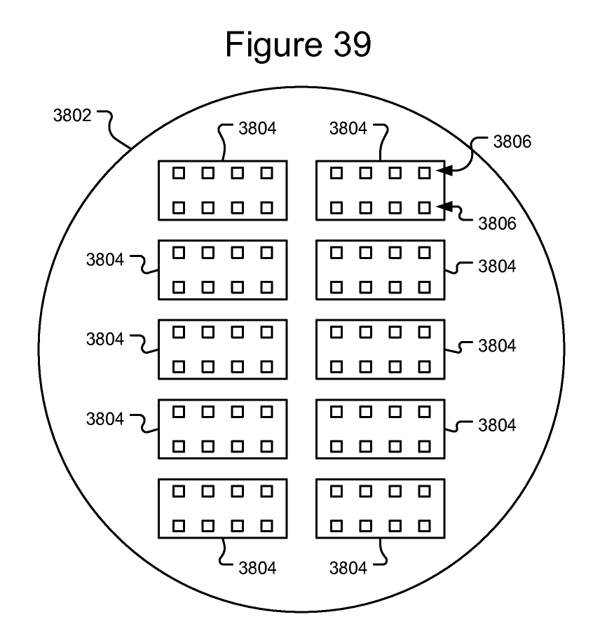

Another example of an electronics device on which contact structures like contact structures 1502 can be formed is a semiconductor wafer, such as shown in FIG. 39. The semiconductor wafer 3802 can include a plurality of unsingulated dies 3804. Using the techniques described above, contact structures (e.g., 1502 of FIG. 16B) can be formed on bond pads 3806 of the dies of the wafer. As yet another example, contact structures can be formed on singulated dies (packaged or unpackaged).

Summarizing and reiterating to some extent, methods of making and using a tooling die have been disclosed herein. Although the invention is not so limited, some embodiments of the invention provide advantages in the forming of tooling dies and forming contact structures. For example, using the printing processes described herein, fine-featured and intricate details can be precisely placed on a substrate to enable the economical production of tooling dies suitable for forming fine-pitch contact structures. The printing processes can also be used to deposit conductive layers, simplifying the formation of plated structures while avoiding the need to sputter or other wise form a conductive seed layer to facilitate plating.

Although specific embodiments and applications of the invention have been described in this specification, these embodiments and applications are exemplary only, and many variations are possible. Particular exemplary contact structures and tooling dies have been disclosed, but it will be apparent that the inventive concepts described above can apply equally to alternate shapes and arrangements. Moreover, while specific exemplary processes for fabricating contact structures and tooling dies have been disclosed, variations in the order of the processing steps, substitution of alternate processing steps, elimination of some processing steps, or combinations of multiple processing steps that do not depart from the inventive concepts are contemplated. Accordingly, the invention is not to be limited except as defined by the following claims.

1. A method of making a tooling die, the method comprising:
depositing a plurality of layers onto a substrate using a printing process, the plurality of layers comprising first portions and second portions, wherein the first portions define a desired shape of the tooling die;
selectively removing the second portions to expose a surface defined by the first portions;
depositing an electrically conductive material onto the exposed surface to form an electrically conductive seed layer; and
electrodepositing a structural material onto the seed layer to form the tooling die.

2. The method of claim 1, wherein the printing process comprises jetting ones of the plurality of layers onto one of a previous layer and the substrate.

3. The method of claim 1, wherein ones of the plurality of layers are defined by a plurality of droplets.

4. The method of claim 1, wherein the depositing the electrically conductive material comprises printing droplets of the electrically conductive material onto the exposed surface to form the electrically conductive seed layer, wherein the electrically conductive seed layer comprises the printed droplets.

5. The method of claim 1, wherein:
the first portions are defined by a first material insoluble in a selected solvent and the second portions are defined by a second material soluble in the selected solvent; and
selectively removing the second portions comprises applying the solvent to the plurality of layers.

6. The method of claim 5, further comprising applying a second solvent to the plurality of layers in which the first material is soluble to remove the tooling die from the substrate.

7. The method of claim 1, further comprising planarizing ones of the layers of material prior to depositing a next one of the layers of material.

8. The method of claim 1, further comprising separating the tooling die from the substrate and the first portions.

9. The method of claim 8 further comprising attaching the tooling die to a backing plate.

10. The method of claim 1, further comprising using the tooling die to emboss a moldable material disposed on a third substrate.

11. The method of claim 1, further comprising using the tooling die to form a contact structure on an electronic component.

12. A tooling die formed in accordance with the method of claim 1.

13. A method of making a tooling die, the method comprising:
forming on a first substrate a plurality of first droplets into a support structure in a shape corresponding to a desired shape of the tooling die;
depositing a plurality of electrically conductive second droplets onto the support structure in sufficient proximity one to another to form an electrically conductive seed layer on the support structure; and
electrodepositing a structural material onto the seed layer.

14. The method of claim 13 further comprising:
attaching the structural material to a second substrate; and
releasing the structural material from the first substrate.

15. The method of claim 14, wherein the forming comprises:
depositing the first droplets and a plurality of third droplets as an array of droplets on the first substrate; and
removing the third droplets.

16. The method of claim 15, wherein the first droplets comprise a first material and the third droplets comprise a second material different than the first material.

17. The method of claim 15, wherein the third droplets are dissolvable by a solvent that does not appreciably dissolve the first droplets.

18. A tooling die made by the method of claim 13.

19. A method of making a contact structure, the method comprising:
forming a moldable material on an electronic component;
pressing a tooling die into the moldable material to form a pattern in the moldable material;
printing an electrically conductive material onto the moldable material and exposed portions of the electronic component to form an electrically conductive seed layer; and
forming a contact structure by electrodepositing structural material onto the seed layer.

20. The method of claim 19, wherein the pressing the tooling die into the moldable material comprises forming a depression in the moldable material, the depression comprising a sloped portion extending laterally from a terminal of the electronic component.

21. The method of claim 20 further comprising, prior to the pressing the tooling die, forming an opening in the moldable material, the opening exposing the terminal, the opening comprising a gap adjacent the terminal exposing a portion the electronic device.

22. The method of claim 19, wherein the printing the electrically conductive material comprises depositing a plurality of droplets of the conductive material onto portions of the moldable material and the exposed portions of the electronic component.

23. The method of claim 19, wherein the printing the electrically conductive material comprises jetting the conductive material onto portions of the moldable material and the exposed portions of the electronic component

24. The method of claim 19, wherein the printing the electrically conductive material comprises depositing conductive droplets on only a first portion of the terminal, and the forming the contact structure comprises electrodepositing the structural material onto the seed layer and a second portion of the terminal.

25. The method of claim 19, wherein the electrically conductive material is a conductive polymer.

26. The method of claim 19, wherein the electrically conductive material is a suspension of conductive particles within a solution.

27. The method of claim 19, wherein the forming a contact structure comprises forming a base portion attached to a terminal of the electronic component and a cantilevered beam portion extending from the base portion and spaced from the electronic component.

28. The method of claim 27, wherein the forming a contact structure further comprises forming a tip portion on the cantilever mean portion.

29. The method of claim 19, wherein the printing the electrically conductive material comprises depositing droplets of the electrically conductive material using a print head.

30. The method of claim 19, wherein:
the pattern comprises a plurality of depressions disposed proximate a plurality of terminals of the electronic component;
the depositing an electrically conductive material comprises depositing electrically conductive material into ones of the plurality of depressions to form electrically conductive seed layers on the ones of the plurality of depressions; and
the forming a contact structure comprises forming a plurality of contact structures by electrodepositing structural material onto ones of the seed layers.

31. The method of claim 30, wherein the electronic component is part of one of a probe card assembly, a semiconductor die test socket, and a plurality of semiconductor dies.

32. The method of claim 30, wherein the electronic component is part of an interposer substrate of a probe card assembly.

33. The method of claim 30, wherein the electronic component is part of a probe substrate of a probe card assembly.

34. The method of claim 30, wherein the electronic component is part of a semiconductor wafer having a plurality of unsingulated dies.

35-67. (canceled)
